(19) United States
(12) Patent Application Publication
(10) Pub. No.: US 2025/0018585 A1
(43) Pub. Date: Jan. 16, 2025

(54) UNDER-ACTUATION TYPE GRIPPER CAPABLE OF GRIPPING ASYMMETRICAL OBJECT

(71) Applicant: PERAZAH INC., Ansan-si (KR)

(72) Inventors: Jong Tae Seo, Ansan-si (KR); Abid Imran, Ansan-si (KR); Muhammad Aqib, Ansan-si (KR)

(21) Appl. No.: 18/765,383

(22) Filed: Jul. 8, 2024

(30) Foreign Application Priority Data
Jul. 10, 2023 (KR) 10-2023-0089017

(51) Int. Cl. B25J 15/08; B25J 9/10

(52) U.S. Cl. CPC B25J 15/08; B25J 9/106

(57) ABSTRACT

An under-actuation type gripper capable of gripping asymmetrical objects is provided. The under-actuation type gripper may include: a frame providing a base surface; at least two or more finger portions provided on the frame in a form of facing each other and having a finger tip at an end; and a driving portion mounted onto the frame and configured to provide a driving force to the finger portion so as to grip an object to be gripped, wherein the finger portion includes: a first link installed between the driving portion and the finger tip, providing a contact surface for the object to be gripped, and having at least one joint portion; a second link connected to longitudinal upper and lower ends of the first link and forming a trapezoidal link mechanism with the first link; and a third link connected to longitudinal upper and lower ends of the first link, forming a double parallelogram link mechanism with the first link in a longitudinal direction of the first link, and being unlocked from the second link.

### CROSS-REFERENCE TO RELATED APPLICATIONS

This application claims the priority of the Korean Patent Applications NO 10-2023-0089017, filed on Jul. 10, 2023, in the Korean Intellectual Property Office. The entire disclosures of all these applications are hereby incorporated by reference.

### BACKGROUND OF THE INVENTION

### 1. Field of the Invention

The present invention relates to an under-actuation type gripper and, more specifically, to an under-actuation type gripper capable of stably gripping asymmetrical objects and having excellent efficiency for adaptive gripping.

### 2. Description of the Prior Art

Currently, robots have become an integral part of automating a manufacturing industry. Robots have advantages of being more more and time-superior past economical, productive, than manufacturing industries in which humans played a productive role. Accordingly, collaboration between humans and robots is taking place in industrial sites, and thus production efficiency is being improved.

With the development of the robot industry, many changes have occurred in a conventional automation system. As robot technology is gradually advanced, robots are being used in various ways throughout the manufacturing industry, and the scope of use thereof is also expanding.

Recently, a robot gripper capable of gripping various objects has been developed. However, the robot gripper is optimized to grip an object which is bilaterally symmetrical.

In other words, in the case of the conventional robot gripper, as fingers are closed up or spread out in the same manner, it is efficient only to grip a standardized product which is bilaterally symmetrical, and there is a limit to stably grip an asymmetrical object.

In addition, it is also not easy to grip and move a thin object placed on an inclined surface with a conventional gripper.

Thus, there is a demand for developing a gripper capable of stably gripping even an asymmetrical object or a thin object placed on an inclined surface.

In other words, there is a need to develop a gripper without restriction on an object to be gripped and an operating environment.

### SUMMARY OF THE INVENTION

One technical object of the present invention is to provide an under-actuation type gripper capable of stably gripping asymmetrical objects.

Another technical object of the present invention is to provide an under-actuation type gripper having excellent efficiency for adaptive gripping.

Still another technical object of the present invention is to provide an under-actuation type gripper capable of actively controlling a finger tip.

The technical objects of the present invention are not limited to the above.

To solve above one technical object, the present invention may provide an under-actuation type gripper.

According to one embodiment, the under-actuation type gripper may include: a frame providing a base surface; at least two or more finger portions provided on the frame in a form of facing each other and having a finger tip at an end; and a driving portion mounted onto the frame and configured to provide a driving force to the finger portion so as to grip an object to be gripped, wherein the finger portion includes: a first link installed between the driving portion and the finger tip, providing a contact surface for the object to be gripped, and having at least one joint portion; a second link connected to longitudinal upper and lower ends of the first link and forming a trapezoidal link mechanism with the first link; and a third link connected to longitudinal upper and lower ends of the first link, forming a double parallelogram link mechanism with the first link in a longitudinal direction of the first link, and being unlocked from the second link.

According to one embodiment, the object to be gripped may be provided as an asymmetrical object, in which when the asymmetrical object is gripped by the at least two or more finger portions, the first link may closely adhere to a surface of the asymmetrical object by the unlocking while adapting to the surface of the asymmetrical object such that a contact area with the asymmetrical object may reach a maximum.

According to one embodiment, a linear motion portion may be further included, in which the linear motion portion may be connected to the at least two or more finger portions, and may linearly move the at least two or more finger portions on the frame.

According to one embodiment, the finger portion may further include a variable link, in which the variable link may be installed between the driving portion and the first link, and a position thereof may be varied on the frame through a linear motion by the linear motion portion.

According to one embodiment, the linear motion portion may perform a linear motion through the variable link in a direction in which the at least two or more finger portions meet each other to form a closed mode, or may perform a linear motion in a direction in which the at least two or more finger portions are away from each other to form an open mode.

According to one embodiment, the linear motion portion may include: a sliding axis; and a sliding block connected to the variable link and configured to receive a driving force from the driving portion to slide in a longitudinal direction of the sliding axis, thereby varying a position of the variable link.

According to one embodiment, the first link may include: a first-1 link having one longitudinal end connected to the variable link; and a first-2 link having one longitudinal end joint-coupled with an other longitudinal end of the first-1 link, and the second link may include: a second-1 link having a horizontal portion and a vertical portion, in which an end of the horizontal portion is connected to the variable link; and a second-2 link having one longitudinal end joint-coupled with an other longitudinal end of the first-2 link, in which the longitudinal end is joint-coupled with an end of the vertical portion of the second-1 link, wherein the vertical portion of the second-1 link may be equal to a length of the first-1 link or longer than the length of the first-1 link.

According to one embodiment, the third link may include: a third-1 link installed between the driving portion and the first-2 link and driven by the driving portion to operate the finger tip; a third-2 link installed between the third-1 link and the first-2 link, in which both longitudinal ends thereof are joint-coupled with the third-1 link and the first-2 link, respectively; a third-3 link having a bent portion rotatably connected to a first joint portion in which the first-1 link and the first-2 link are joint-coupled; a third-4 link installed between the finger tip and the third-3 link and having one longitudinal end joint-coupled to the third-3 link; and a third-5 link installed between the finger tip and the third-4 link and having both longitudinal ends joint-coupled to the finger tip and the third-4 link, respectively.

According to one embodiment, the first-2 link may include at least one joint portion in a longitudinal direction.

According to one embodiment, the driving portion may include one motor, and the at least two or more finger portions may be under-actuated by the one motor.

According to one embodiment, the object to be gripped may include an object placed on an inclined surface and an asymmetrical object.

According to an embodiment of the present invention, an under-actuation type gripper may include: a frame providing a base surface; at least two or more finger portions provided on the frame in a form of facing each other and having a finger tip at an end; and a driving portion mounted onto the frame and configured to provide a driving force to the finger portion so as to grip an object to be gripped, in which the finger portion may include: a first link installed between the driving portion and the finger tip, providing a contact surface for the object to be gripped, and having at least one joint portion; a second link connected to longitudinal upper and lower ends of the first link and forming a trapezoidal link mechanism with the first link; and a third link connected to longitudinal upper and lower ends of the first link, forming a double parallelogram link mechanism with the first link in a longitudinal direction of the first link, and being unlocked from the second link.

Accordingly, an under-actuation type gripper capable of stably gripping asymmetrical objects may be provided.

In addition, according to an embodiment of the present invention, an under-actuation type gripper having excellent efficiency for adaptive gripping may be provided, and thus a thin object placed on an inclined surface may also be stably gripped and moved.

Furthermore, according to an embodiment of the present invention, an under-actuation type gripper capable of actively controlling a finger tip by including a double parallelogram link mechanism may be provided.

As described above, according to an embodiment of the present invention, an under-actuation type gripper having an excellent gripping performance may be provided.

### BRIEF DESCRIPTION OF THE DRAWINGS

FIG. 1 is a view for illustrating an under-actuation type gripper according to one embodiment of the present invention.

FIG. 2 is a view for illustrating a finger portion of an under-actuation type gripper according to one embodiment of the present invention.

FIG. 3 is a view for illustrating a finger portion of an under-actuation type gripper according to a first modified example of the present invention.

FIG. 4 is a view for illustrating a finger portion of an under-actuation type gripper according to a second modified example of the present invention.

FIG. 5 is a view of showing a state in which an under-actuation type gripper according to one embodiment of the present invention grips an object to be gripped.

FIG. 6 is a view of showing a state in which an under-actuation type gripper according to a first modified example of the present invention grips an object to be gripped.

FIG. 7 is a view of showing a state in which an under-actuation type gripper according to a second modified example of the present invention grips an object to be gripped.

FIGS. 8 and 9 are views for comparing a gripping form for an object to be gripped between a gripper according to the related art and an under-actuation type gripper according to one embodiment of the present invention.

FIG. 10 is a view of showing a picture in which an under-actuation type gripper according to one embodiment of the present invention grips an asymmetrical object.

FIGS. 11 to 13 are views of showing pictures stage by stage in which an under-actuation type gripper according to one embodiment of the present invention grips an object placed on an inclined surface.

### DETAILED DESCRIPTION OF THE EXEMPLARY EMBODIMENTS

Hereinafter, preferred embodiments of the present invention will be described in detail with reference to the accompanying drawings. However, the technical idea of the present invention is not limited to the embodiments described herein and may be embodied in other forms. The embodiments introduced herein are provided to sufficiently deliver the spirit of the present invention to those skilled in the art so that the disclosed contents may become thorough and complete.

When it is mentioned in the specification that one element is on another element, it means that the first element may be directly formed on the second element or a third element may be interposed between the first element and the second element. Further, in the drawings, a shape and a size are exaggerated for efficient description of the technical contents.

In addition, in the various embodiments of the present specification, the terms such as first, second, and third are used to describe various elements, but the elements are not limited to the terms. The terms are used only to distinguish one element from another element. Accordingly, an element mentioned as a first element in one embodiment may be mentioned as a second element in another embodiment. Each of the embodiments described and illustrated herein also include their complementary embodiments. Further, the term “and/or” in the present specification is used to include at least one of the elements enumerated in the specification.

In the specification, the terms of a singular form may include plural forms unless otherwise specified. Further, the terms “including” and “having” are used to designate that the features, the numbers, the steps, the elements, or combinations thereof described in the specification are present, and are not to be understood as excluding the possibility that one or more other features, numbers, steps, elements, or combinations thereof may be present or added. In addition, the term “connection” used herein may include the meaning of indirectly connecting a plurality of components, and directly connecting a plurality of components.

Further, in the following description of the present invention, a detailed description of known functions and configurations incorporated herein will be omitted when it may make the subject matter of the present invention unnecessarily unclear.

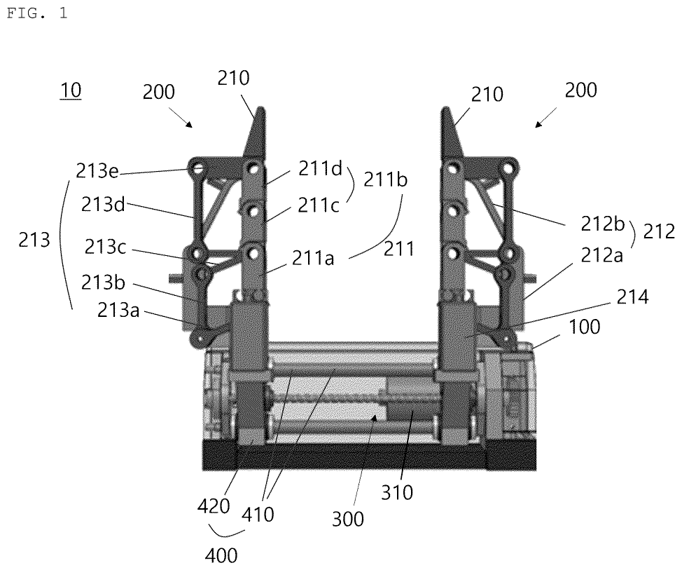

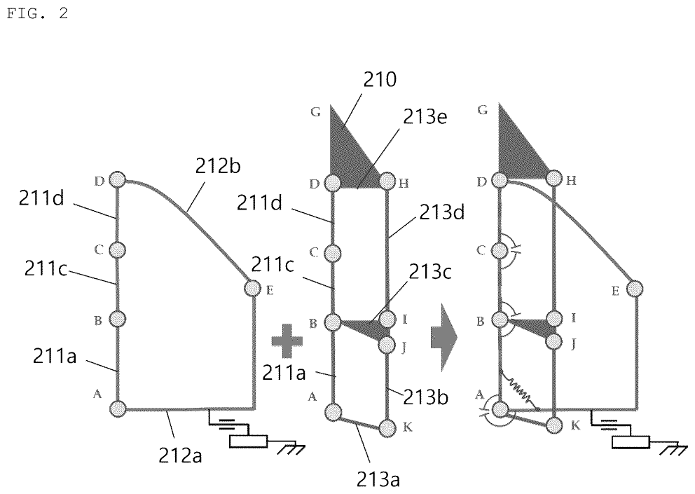

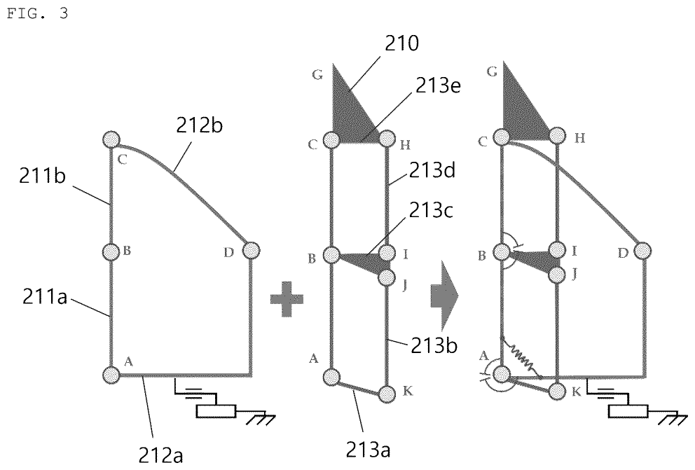

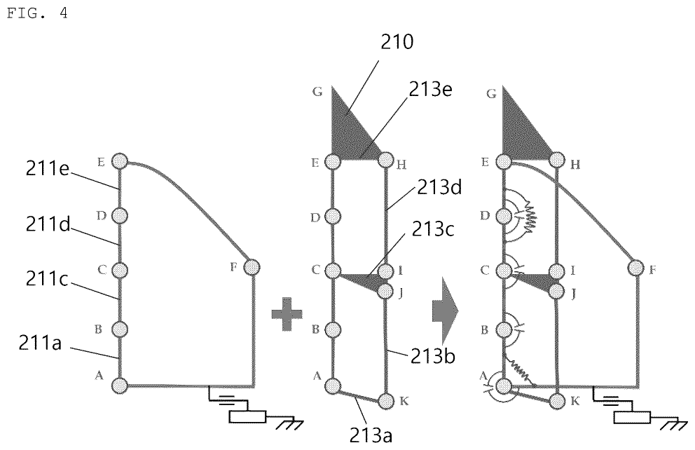

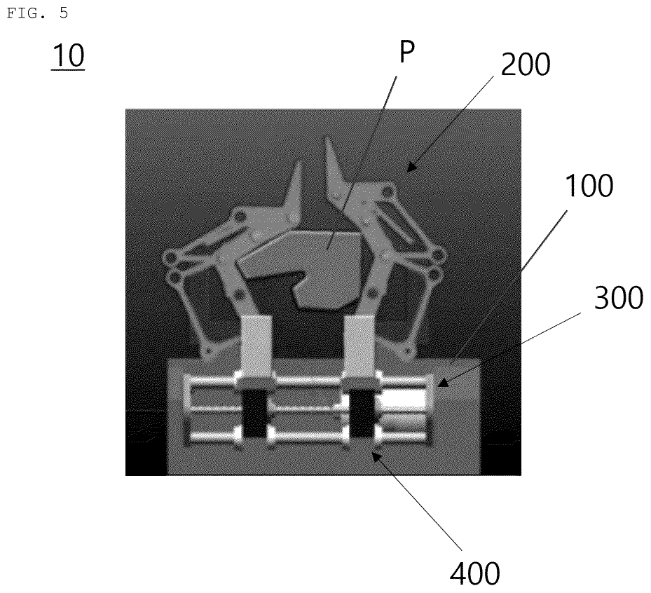

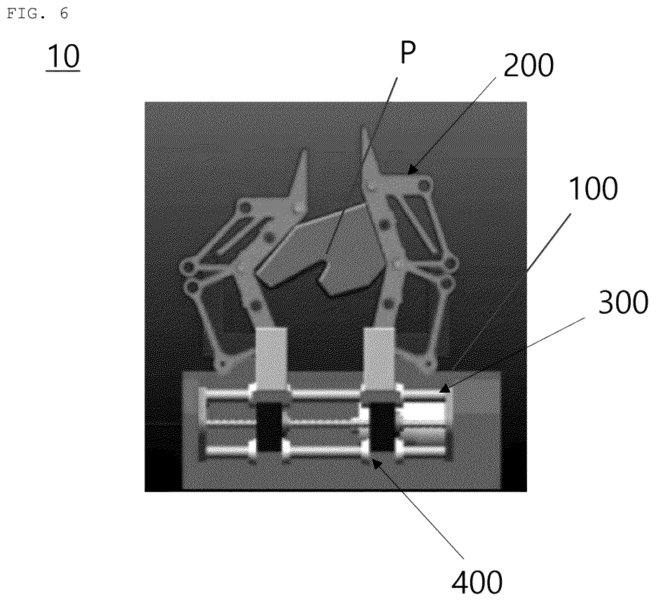

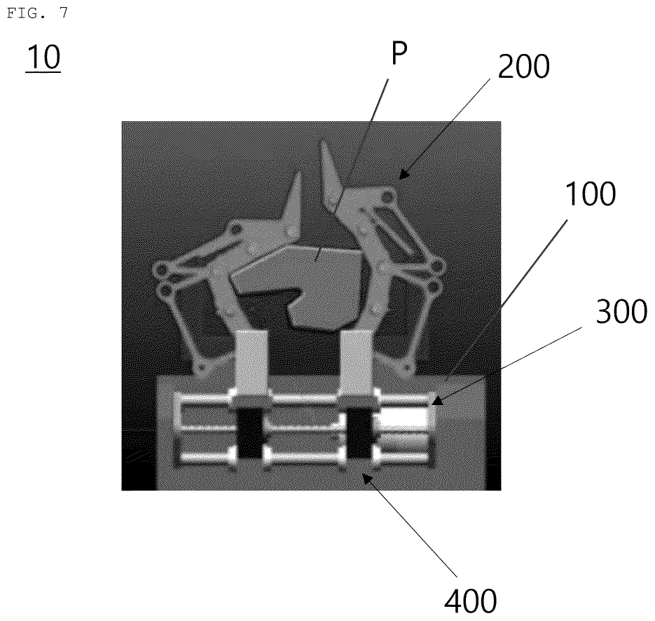

FIG. 1 is a view for illustrating an under-actuation type gripper according to one embodiment of the present invention, FIG. 2 is a view for illustrating a finger portion of an under-actuation type gripper according to one embodiment of the present invention, FIG. 3 is a view for illustrating a finger portion of an under-actuation type gripper according to a first modified example of the present invention, FIG. 4 is a view for illustrating a finger portion of an under-actuation type gripper according to a second modified example of the present invention, FIG. 5 is a view of showing a state in which an under-actuation type gripper according to one embodiment of the present invention grips an object to be gripped, FIG. 6 is a view of showing a state in which an under-actuation type gripper according to a first modified example of the present invention grips an object to be gripped, and FIG. 7 is a view of showing a state in which an under-actuation type gripper according to a second modified example of the present invention grips an object to be gripped.

As shown in FIG. 1, the under-actuation type gripper 10 according to one embodiment of the present invention may stably grip any object to be gripped P without restriction on a shape of the object to be gripped P (P of FIG. 5).

For example, the under-actuation type gripper 10 according to one embodiment of the present invention may stably grip an asymmetrical object through adaptive gripping even when the object to be gripped P is an asymmetrical object.

In addition, the under-actuation type gripper 10 according to one embodiment of the present invention may stably grip an object to be gripped P without restriction on an environment in which the object to be gripped P is placed.

For example, the under-actuation type gripper 10 according to one embodiment of the present invention may also stably grip a thin object to be gripped P placed on an inclined surface.

For this purpose, the under-actuation type gripper 10 according to one embodiment of the present invention may be formed to include a frame 100, a finger portion 200, and a driving portion 300.

The frame 100 may provide a base surface for the finger portion 200 provided to face in an upward direction (based on the drawing). The frame 100 may support the finger portion 200 and may provide a height to the finger portion 200.

In addition, according to one embodiment of the present invention, the frame 100 may provide a space for installing the driving portion 300.

In this case, the frame 100 may be mounted on a separate lifting device to be raised and lowered. Accordingly, the finger portion 200 may be lowered toward the object to be gripped P and then raised after gripping the object to be gripped P.

The finger portion 200 may be provided upward from an upper side with an upper surface of the frame 100 that serves as a base surface. At least two or more finger portions 200 may be provided to grip the object to be gripped P.

Hereinafter, for convenience of description, it may be assumed that the finger portion 200 is provided as one pair.

According to one embodiment of the present invention, the pair of finger portions 200 may face each other in a symmetrical manner so as to be able to grip the object to be gripped P.

In this case, a finger tip 210 serving as a fingertip may be provided at an end of each finger portion 200. The finger tip 210 may have a contact surface capable of gripping the object to be gripped P.

The pair of finger portions 200 may be provided in a direction in which the contact surfaces of the finger tip 210 face each other. In this case, the finger tip 210 in an initial state may be set such that the contact surface thereof forms a vertical surface perpendicular to the upper surface of the frame 100.

According to one embodiment of the present invention, the finger portion 200 may include a first link 211, a second link 212, a third link 213, and a variable link 214 to support the finger tip 210 and grip the object to be gripped P.

The first link 211 may be installed between the driving portion 300 and the finger tip 210. In this case, the first link 211 may not be driven by the driving portion 300.

The first link 211 may provide a contact surface for the object to be gripped P. In addition, the first link 211 may have at least one joint portion for adaptive gripping with respect to the object to be gripped P.

Referring to FIG. 2, according to one embodiment of the present invention, the first link 211 may include a first-1 link 211a and a first-2 link 211b.

One longitudinal end of the first-1 link 211a may be connected to the variable link 214, and an other longitudinal end thereof may be joint-coupled with the first-2 link 211b.

One longitudinal end of the first-2 link 211b may be joint-coupled with the other longitudinal end of the first-1 link 211a, and an other longitudinal end thereof may be connected to the finger tip 210.

Accordingly, according to one embodiment of the present invention, the first link 211 may have a first joint portion B at a connection site between the first-1 link 211a and the first-2 link 211b.

In this case, the first-2 link 211b may include at least one joint portion in a longitudinal direction.

According to one embodiment of the present invention, the first-2 link 211b may include a first-3 link 211c and a first-4 link 211d.

One longitudinal end of the first-3 link 211c may be joint-coupled with the other longitudinal end of the first-1 link 211a to form the first joint portion B.

One longitudinal end of the first-4 link 211d may be joint-coupled with the other longitudinal end of the first-3 link 211c to form a second joint portion C.

An other longitudinal end of the first-4 link 211d may be connected to the finger tip 210 through a third joint portion D.

Meanwhile, as shown in FIG. 3, according to a first modified example of the present invention, the first link 211 may have only a first joint portion B in a longitudinal direction.

In addition, as shown in FIG. 4, according to a second modified example of the present invention, the first-2 link 211b may include a first-3 link 211c, a first-4 link 211d and a first-5 link 211e.

One longitudinal end of the first-3 link 211c may be joint-coupled with the other longitudinal end of the first-1 link 211a to form the first joint portion B.

One longitudinal end of the first-4 link 211d may be joint-coupled with the other longitudinal end of the first-3 link 211c to form a second joint portion C.

One longitudinal end of the first-5 link 211e may be joint-coupled with the other longitudinal end of the first-4 link 211d to form a third joint portion D.

In this case, an other longitudinal end of the first-5 link 211e may be connected to the finger tip 210 through a fourth joint portion E.

FIG. 5 is a view of showing a state in which an under-actuation type gripper according to one embodiment of the present invention grips an object to be gripped, FIG. 6 is a view of showing a state in which an under-actuation type gripper according to a first modified example of the present invention grips an object to be gripped, and FIG. 7 is a view of showing a state in which an under-actuation type gripper according to a second modified example of the present invention grips an object to be gripped.

Referring to FIGS. 5 to 7, it can be confirmed that the object to be gripped P is more stably gripped, as the number of links forming the first link 211 in contact with the object to be gripped P formed of an asymmetrical object increases.

In other words, as the first link 211 has more joint portions in a longitudinal direction, a contact surface with the object to be gripped P increases, and thus it can be confirmed that the object to be gripped P is more stably gripped.

The second link 212 may form a trapezoidal link mechanism with the first link 211. For this purpose, the second link 212 may be connected to upper and lower ends of the first link 211 in a longitudinal direction to form a trapezoid-shaped link mechanism.

According to one embodiment of the present invention, the second link 212 may include a second-1 link 212a and a second-2 link 212b.

The second-1 link 212a may have a horizontal portion and a vertical portion. In other words, the second-1 link 212a may have a bent structure in a longitudinal direction. The second-1 link 212a may be connected to a variable link 214. In this case, an end of a horizontal portion of the second-1 link 212a may be connected to a variable link 214.

According to one embodiment of the present invention, a vertical portion of the second-1 link 212a may have a length shorter than a length of the first link 211 in order to form a trapezoid-shaped link mechanism.

In this case, the vertical portion of the second-1 link 212a may be equal to a length of the first-1 link 211a or longer than the length of the first-1 link 211a.

The third link 213 may form a double parallelogram link mechanism with the first link 211 in a longitudinal direction of the first link 211. For this purpose, the third link 213 may be connected to upper and lower ends of the first link 211 in a longitudinal direction to form a double parallelogram link mechanism.

As described above, according to one embodiment of the present invention, the finger portion 200 may be provided as a combination of a trapezoidal link mechanism formed by the first link 211 and the second link 212 and a double parallelogram link mechanism formed by the first link 211 and the third link 213.

In this case, according to one embodiment of the present invention, the dual parallelogram link mechanism may be unlocked from the trapezoidal link mechanism. More specifically, the third link 213 may be unlocked from the second link 212.

As described above, when the third link 213 is unlocked from the second link 212, interference between the trapezoidal link mechanism and the double parallelogram link mechanism may be minimized, and thus a degree of freedom of the first link 211 forming a contact surface for the object to be gripped P may be increased to improve efficiency of adaptive gripping.

For example, when the object to be gripped P formed of an asymmetrical object is gripped by the pair of finger portions 200, the first link 211 may closely adhere to the surface of the object to be gripped P by an unlocking structure between the second link 212 and the third link 213 while adapting to the surface of the object to be gripped P such that a contact area with the object to be gripped P formed of an asymmetrical object may reach a maximum.

In this case, each of the first links 211 of the pair of finger portions 200 may independently move for adaptive gripping of the object to be gripped P formed of an asymmetrical object, and thus when the object to be gripped P formed of an asymmetrical object is completely gripped, each of the first links 211 may also form an asymmetrical structure with each other.

Referring to FIG. 2 again, according to one embodiment of the present invention, the third link 213 may include a third-1 link 213a, a third-2 link 213b, a third-3 link 213c, a third-4 link 213d, and a third-5 link 213e.

The third-1 link 213a may be installed between the driving portion 300 and the first-2 link 211b. In this case, the third-1 link 213a may be connected to the first-2 link 211b through the third-2 link 213b and the third-3 link 213c.

One longitudinal end of the third-1 link 213a may be connected to the driving portion 300, and an other longitudinal end thereof may be joint-coupled to one longitudinal end of the third-2 link 213b.

According to one embodiment of the present invention, the third-1 link 213a may be driven by the driving portion 300 to operate the finger tip 210.

In this case, according to one embodiment of the present invention, the finger portion 200 may further include an elastic support member.

The elastic support member may be installed between a first-1 link 211a of the first link 211 and a third-1 link 213a. When an inclination of the first-1 link 211a is changed, the elastic support member may return the first-1 link 211a to an initial posture or an initial inclination state through an elastic restoring force.

According to one embodiment of the present invention, the first-1 link 211a may be elastically supported by the elastic support member as described above, thereby having high adhesion to the object to be gripped P upon adaptive gripping. Accordingly, the object to be gripped P may be stably gripped.

The third-2 link 213b may be installed between the third-1 link 213a and the first-2 link 211b. One longitudinal end of the third-2 link 213b may be joint-coupled with an other longitudinal end of the third-1 link 213a, and an other longitudinal end thereof may be joint-coupled to one longitudinal end of the third-3 link 213c.

The third-3 link 213c may be provided as a “V”-shaped link in which a center in a longitudinal direction is bent for amplification of a rotational angle.

According to one embodiment of the present invention, a bent portion of the third-3 link 213c may be rotatably connected to a first joint portion B in which the first-1 link 211a and the first-2 link 211b are joint-coupled.

One longitudinal end of the third-3 link 213c may be joint-coupled with an other longitudinal end of the third-2 link 213b, and an other longitudinal end thereof may be joint-coupled with one longitudinal end of the third-4 link 213d.

The third-4 link 213d may be installed between the finger tip 210 and the third-3 link 213c. More specifically, the third-4 link 213d may be installed between the third-5 link 213e and the third-3 link 213c.

In other words, one longitudinal end of the third-4 link 213d may be joint-coupled with an other longitudinal end of the third-3 link 213c, and an other longitudinal end thereof may be joint-coupled to one longitudinal end of the third-5 link 213e.

An other longitudinal end of the third-5 link 213e may be rotatably connected to, that is, joint-coupled to a third joint portion D formed in such a way that the finger tip 210 and the first link 211, more specifically, the finger tip 210 and the first-2 link 211b of the first link 211 are joint-coupled, and one longitudinal end thereof may be joint-coupled (H) to an other longitudinal end of the third-4 link 213d.

As described above, the third-1 link 213a connected to the finger tip 210 through the third-2 link 213b, the third-3 link 213c, the third-4 link 213d, and the third-5 link 213e may be rotated by the driving portion 300.

As described above, when the third-1 link 213a, which is a driving link, is rotated by the driving portion 300, the third-2 link 213b, the third-3 link 213c, the third-4 link 213d, and the third-5 link 213e may be sequentially operated.

Accordingly, a direction of the finger tip 210 connected to the third-5 link 213e may be switched.

In other words, when the third-1 link 213a, which is a driving link, is rotated by the driving portion 300, an inclination may be changed so that a contact surface of the finger tip 210, which is set to be perpendicular to an upper surface of the frame 100 in an initial state, may form an inclined surface.

Accordingly, the contact surfaces of the finger tips 210 located at both sides may be inclined, for example, in a direction of facing each other, thereby pinch-gripping the object to be gripped P positioned between the finger tips 210 located at both sides.

The variable link 214 may be installed between the driving portion 300 and the first link 211. A position of the variable link 214 may be varied on the frame 100 through a linear motion by a linear motion portion 400 to be described below.

According to one embodiment of the present invention, the pair of finger portions 200 may linearly move in a direction in which the finger portions meet each other on the frame 100 or may linearly move in a direction in which the finger portions are away from each other by the variable link 214.

Referring to FIG. 1 again, the under-actuation type gripper 10 according to one embodiment of the present invention may further include a linear motion portion 400.

The linear motion portion 400 may be connected to the pair of finger portions 200. Specifically, the linear motion portion 400 may be connected to the finger portion 200 through the variable link 214.

The linear motion portion 400 may linearly move the pair of finger portions 200 on the frame 100. In this case, the linear movement portion 400 may linearly move the pair of finger portions 200 in opposite directions to each other.

According to one embodiment of the present invention, the linear motion portion 400 may configured to receive a driving force from the driving portion 300.

Specifically, the linear motion portion 400 which has received the driving force from the driving portion 300 may linearly move the pair of finger portions 200 in a direction in which the finger portions meet each other through the variable link 214.

Accordingly, the under-actuation type gripper 10 according to one embodiment of the present invention may be switched to a closed mode.

In addition, the linear motion portion 400 which has received the driving force from the driving portion 300 may linearly move the pair of finger portions 200 in a direction in which the finger portions are away from each other through the variable link 214.

Accordingly, the under-actuation type gripper 10 according to one embodiment of the present invention may be switched to an open mode.

For this purpose, according to one embodiment of the present invention, the linear motion portion 400 may include a sliding axis 410 and a sliding block 420.

The sliding axis 410 may be provided in one direction in a trench provided on an upper surface of the frame 100.

The sliding block 420 may be connected to the variable link 214. Specifically, the sliding block 420 may be connected to a lower side of the variable link 214. In this case, the sliding block 420 may be axially coupled to the sliding axis 410.

According to one embodiment of the present invention, the sliding block 420 may receive a driving force from the driving portion 300, and may slide in a longitudinal direction of the sliding axis 410 by the driving force, thereby varying a position of the variable link 214 connected thereto.

For example, when the sliding blocks 420 connected to the variable links 214 located at both sides, respectively, slide in a direction in which the sliding blocks are away from each other along the sliding axis 410, the finger portions 200 located at both sides connected thereto, respectively, may also linearly move in a direction in which the finger portions are away from each other on the frame 100, and thus the under-actuation type gripper 10 may be switched to an open mode.

In addition, when the sliding blocks 420 connected to the variable links 214 located at both sides, respectively, slide in a direction in which the sliding blocks meet each other along the sliding axis 410, the finger portions 200 located at both sides connected thereto, respectively, may also linearly move in a direction in which the finger portions meet each other on the frame 100, and thus the under-actuation type gripper 10 may be switched to a closed mode.

Subsequently, referring to FIG. 1, the driving portion 300 may be mounted on the frame 100. The driving portion 300 may provide a driving force to the finger portion 200 so as to grip the object to be gripped P.

More specifically, the driving portion 300 may provide a driving force to the third-1 link 213a to rotate the third-1 link 213a.

As described above, when the third-1 link 213a is rotated by the driving portion 300, the third-2 link 213b, the third-3 link 213c, the third-4 link 213d, and the third-5 link 213e may be sequentially operated, and thus a direction of the finger tip 210 connected to the third-5 link 213e may be switched.

In other words, when the third-1 link 213a, which is a driving link, is rotated by the driving portion 300, an inclination may be changed so that a contact surface of the finger tip 210, which is set to be perpendicular to an upper surface of the frame 100 in an initial state, may form an inclined surface.

According to one embodiment of the present invention, the driving portion 300 may include one motor 310. Accordingly, the pair of finger portions 200 may be under-actuated by the one motor 310.

In addition, the driving portion 300 may provide a driving force to the linear movement portion 400 in order to linearly move the pair of finger tips 210.

Specifically, the driving portion 300 may provide a driving force to the linear motion portion 400 to slide the sliding block 420 in a longitudinal direction of the sliding axis 410.

Accordingly, the pair of finger portions 200 connected thereto may linearly move in a direction in which the finger portions are away from each other, and on the contrary, may linearly move in a direction in which the finger portions meet each other.

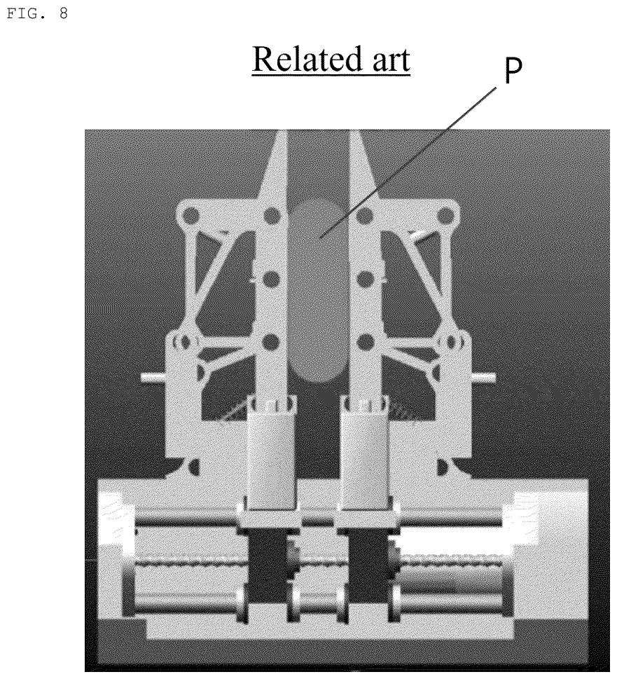

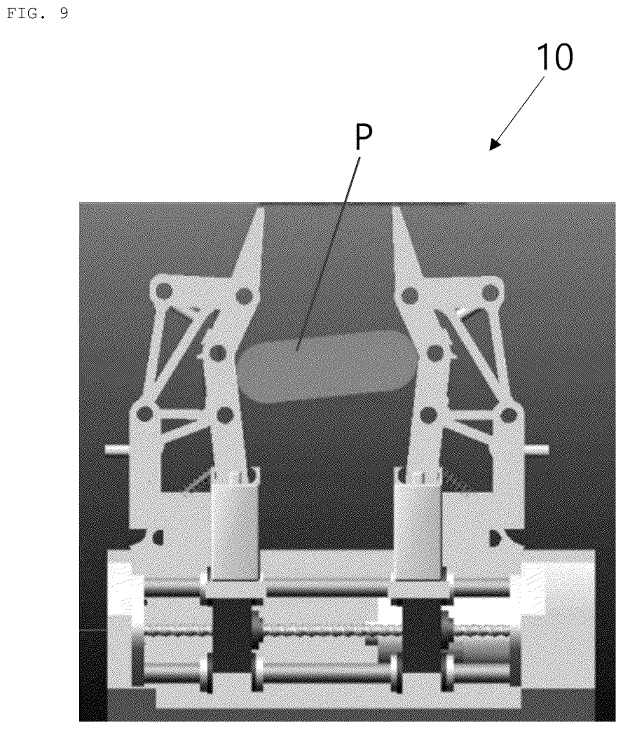

FIGS. 8 and 9 are views for comparing a gripping form for an object to be gripped between a gripper according to the related art and an under-actuation type gripper according to one embodiment of the present invention.

Referring to FIGS. 8 and 9, in the case of the gripper according to the related art, the object to be gripped P may be pressed and closely supported by the finger portions located at both sides, whereas in the case of the under-actuation type gripper 10 according to one embodiment of the present invention, the object to be gripped P may be stably gripped through adaptive gripping, which covers the object to be gripped P.

As described above, the under-actuation type gripper 10 according to one embodiment of the present invention may stably grip even an asymmetrical object through adaptive gripping.

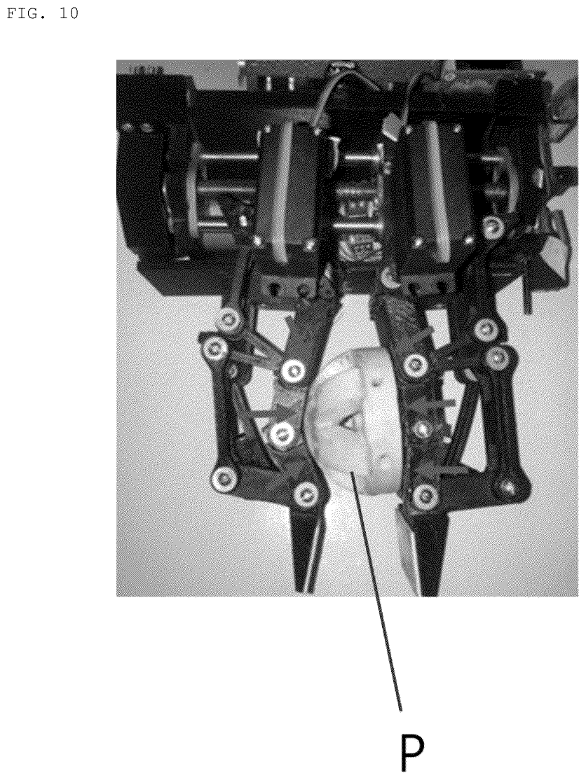

FIG. 10 is a view of showing a picture in which an under-actuation type gripper according to one embodiment of the present invention grips an asymmetrical object.

As shown in the picture of FIG. 10, it can be confirmed that an asymmetrical object in which a left side has a round shape and a right side has a plane shape is stably gripped by the under-actuation type gripper according to one embodiment of the present invention.

In other words, the joints of the finger portions located at both sides may be bent while adapting to a surface of the asymmetrical object so that a contact area with the surface of the asymmetrical object coming into contact may reach a maximum, and thus may closely adhere to the surface of the asymmetrical object.

Accordingly, finger portions located at both sides may also asymmetrically operate upon gripping an asymmetrical object.

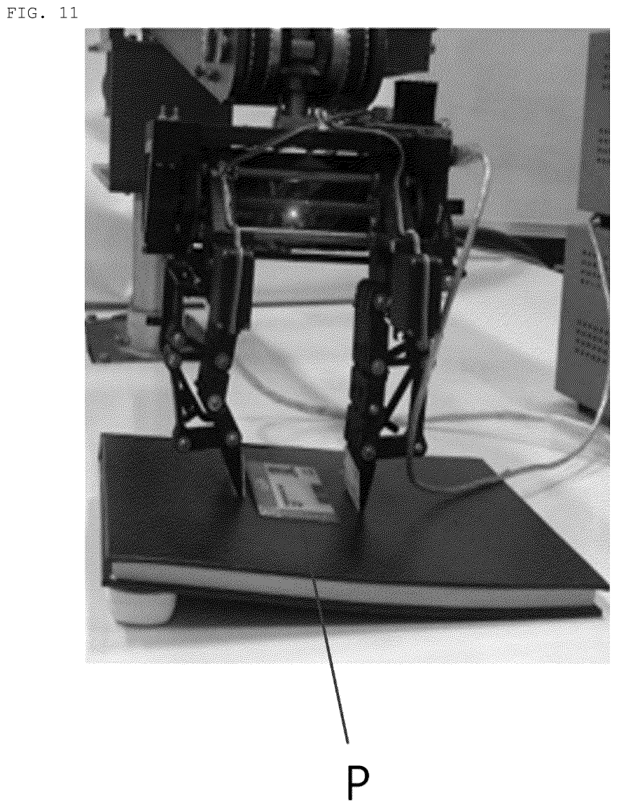

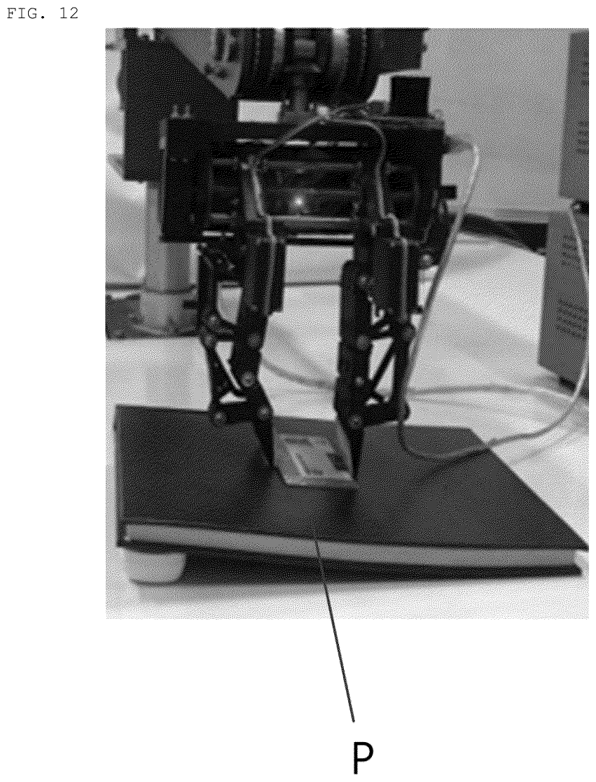

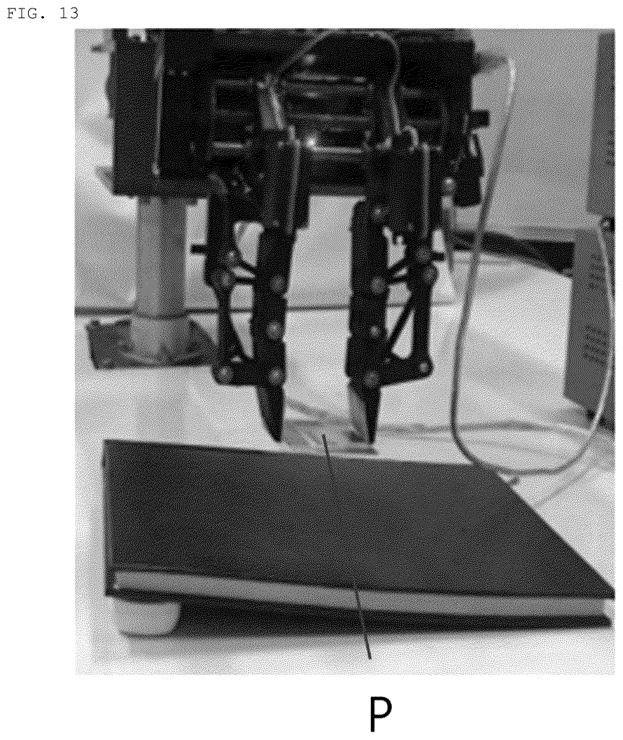

In addition, FIGS. 11 to 13 are views of showing pictures in which an under-actuation type gripper according to one embodiment of the present invention grips an object placed on an inclined surface.

As shown in the pictures, the under-actuation type gripper according to one embodiment of the present invention may grip even a thin object P placed on an inclined surface.

When a finger tip provided at an end of one finger portion of the pair of finger portions comes into contact with the inclined surface first, the corresponding finger portion formed of a combination of a trapezoidal link mechanism and a double parallelogram link mechanism which are unlocked from each other may be bent while adapting to the inclined surface.

In this state, when the finger tip provided at an end of an other finger portion comes into contact with the inclined surface, the finger portions located at both sides may linearly move toward the thin object P positioned at a center.

In this case, the one finger portion of which the finger tip comes into contact with the inclined surface first may be gradually spread out while adapting to the inclined surface such that a contact state between the finger tip and the inclined surface may be continuously maintained during a linear motion.

As described above, the under-actuation type gripper according to one embodiment of the present invention may stably grip an asymmetrical object and even a thin object P placed on an inclined surface.

Subsequently, when the thin object P is pinch-gripped by the finger tips located at both sides, the thin object placed on the inclined surface may be moved by raising the finger portions located at both sides.

In this case, one finger portion, which is bent, may be spread out to be symmetrical to an other finger portion in a process of ascending in order to stably grip an object.

Meanwhile, the under-actuation type gripper according to one embodiment of the present invention may stably place the object to be gripped P on an inclined surface.

In other words, when being lowered toward the inclined surface in a state in which the finger portions located at both sides are symmetrical to each other and the finger tips grip the object to be gripped P, one finger portion which comes into contact with an upper end of the inclined surface first may be bent until an other finger portion comes into contact with a lower end of the inclined surface while adapting to the inclined surface by the trapezoidal link mechanism and the double parallelogram link mechanism which are unlocked from each other.

Accordingly, the object P, which is gripped by both finger tips, may be placed on the inclined surface while a collision with the inclined surface is minimized.

When both finger portions come into contact with the upper and lower ends of the inclined surface, finger portions located at both sides may linearly move in a direction in which the finger portions are away from the thin object P placed in the center.

In this case, one finger portion, which linearly moves to the upper end of the inclined surface, may be further bent while adapting to the inclined surface.

As described above, the under-actuation type gripper according to one embodiment of the present invention may stably grip the thin object P placed on the inclined surface, and may stably place the gripped object P on the inclined surface.

As described above, the under-actuation type gripper 10 according to one embodiment of the present invention may include the finger portion 200 formed of a combination of a trapezoidal link mechanism and a double parallelogram link mechanism which are unlocked from each other.

Accordingly, the under-actuation type gripper 10 according to one embodiment of the present invention may stably grip an asymmetrical object P and have excellent efficiency for adaptive gripping, thereby stably gripping and moving even the thin object P placed on the inclined surface.

In addition, the under-actuation type gripper 10 according to one embodiment of the present invention may actively control the finger tip 210 through the double parallelogram link mechanism.

In other words, the under-actuation type gripper 10 according to one embodiment of the present invention may grip objects to be gripped P having various forms or shapes through the finger tip 210 by adjusting a setting direction of the finger tip 210.

As described above, according to one embodiment of the present invention, the under-actuation type gripper 10 having an excellent gripping performance may be provided.

Although the present invention has been described in detail with reference to exemplary embodiments, the scope of the present invention is not limited to a specific embodiment and should be interpreted by the attached claims. In addition, those skilled in the art should understand that many modifications and variations are possible without departing from the scope of the present invention.

1. An under-actuation type gripper capable of gripping asymmetrical objects, the under-actuation type gripper comprising:
a frame providing a base surface;
at least two or more finger portions provided on the frame in a form of facing each other and having a finger tip at an end; and
a driving portion mounted onto the frame and configured to provide a driving force to the finger portion so as to grip an object to be gripped, wherein the finger portion includes:
a first link installed between the driving portion and the finger tip, providing a contact surface for the object to be gripped, and having at least one joint portion;
a second link connected to longitudinal upper and lower ends of the first link and forming a trapezoidal link mechanism with the first link; and
a third link connected to longitudinal upper and lower ends of the first link, forming a double parallelogram link mechanism with the first link in a longitudinal direction of the first link, and being unlocked from the second link.

2. The under-actuation type gripper of claim 1, wherein the object to be gripped is provided as an asymmetrical object,
wherein when the asymmetrical object is gripped by the at least two or more finger portions, the first link closely adheres to a surface of the asymmetrical object by the unlocking while adapting to the surface of the asymmetrical object such that a contact area with the asymmetrical object reaches a maximum.

3. The under-actuation type gripper of claim 1, further comprising:
a linear motion portion, wherein
the linear motion portion is connected to the at least two or more finger portions, and linearly moves the at least two or more finger portions on the frame.

4. The under-actuation type gripper of claim 3, wherein the finger portion further includes a variable link,
wherein the variable link is installed between the driving portion and the first link, and a position thereof is varied on the frame through a linear motion by the linear motion portion.

5. The under-actuation type gripper of claim 4, wherein
the linear motion portion performs a linear motion through the variable link in a direction in which the at least two or more finger portions meet each other to form a closed mode, or performs a linear motion in a direction in which the at least two or more finger portions are away from each other to form an open mode.

6. The under-actuation type gripper of claim 5, wherein the linear motion portion includes:
a sliding axis; and
a sliding block connected to the variable link and configured to receive a driving force from the driving portion to slide in a longitudinal direction of the sliding axis, thereby varying a position of the variable link.

7. The under-actuation type gripper of claim 4, wherein the first link includes:
a first-1 link having one longitudinal end connected to the variable link; and
a first-2 link having one longitudinal end joint-coupled with an other longitudinal end of the first-1 link, and
the second link includes:
a second-1 link having a horizontal portion and a vertical portion, in which an end of the horizontal portion is connected to the variable link; and
a second-2 link having one longitudinal end joint-coupled with an other longitudinal end of the first-2 link, in which the longitudinal end is joint-coupled with an end of the vertical portion of the second-1 link,
wherein the vertical portion of the second-1 link is equal to a length of the first-1 link or longer than the length of the first-1 link.

8. The under-actuation type gripper of claim 7, wherein the third link includes:
a third-1 link installed between the driving portion and the first-2 link and driven by the driving portion to operate the finger tip;
a third-2 link installed between the third-1 link and the first-2 link, in which both longitudinal ends thereof are joint-coupled to the third-1 link and the first-2 link, respectively;
a third-3 link having a bent portion rotatably connected to a first joint portion in which the first-1 link and the first-2 link are joint-coupled;
a third-4 link installed between the finger tip and the third-3 link and having one longitudinal end joint-coupled to the third-3 link; and
a third-5 link installed between the finger tip and the third-4 link and having both longitudinal ends joint-coupled to the finger tip and the third-4 link, respectively.

9. The under-actuation type gripper of claim 7, wherein the first-2 link includes at least one joint portion in a longitudinal direction.

10. The under-actuation type gripper of claim 1, wherein
the driving portion includes one motor, and
the at least two or more finger portions are under-actuated by the one motor.

11. The under-actuation type gripper of claim 1, wherein the object to be gripped includes an object placed on an inclined surface and an asymmetrical object.
